(19) United States
(12) Patent Application Publication
(10) Pub. No.: US 2025/0254727 A1
(43) Pub. Date: Aug. 7, 2025

(54) ANNOUNCEMENT FOR COORDINATED TIME DIVISION MULTIPLE ACCESS

(71) Applicant: Samsung Electronics Co., Ltd., Suwon-si (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US)

(21) Appl. No.: 19/041,862

(22) Filed: Jan. 30, 2025

Related U.S. Application Data
(60) Provisional application No. 63/550,877, filed on Feb. 7, 2024.
(60) Provisional application No. 63/564,817, filed on Mar. 13, 2024.
(60) Provisional application No. 63/565,417, filed on Mar. 14, 2024.

(51) Int. Cl. H04W 74/0816; H04L 5/00; H04W 72/0446

(52) U.S. Cl. CPC H04W 74/0816; H04L 5/0053; H04W 72/0446

(57) ABSTRACT

A first station (STA) in a wireless network, with a memory and a processor coupled to the memory. The processor is configured to cause obtaining a transmission opportunity (TXOP) on a wireless channel. The processor is further configured to cause transmitting, to one or more second STAs, one or more first frames, each first frame allocating a portion of the TXOP during a corresponding time period, wherein each time period is not overlapping with one or more other time periods.

### CROSS REFERENCE TO RELATED APPLICATION

This application claims benefit of U.S. Provisional Application No. 63/550,877, filed on Feb. 7, 2024, U.S. Provisional Application No. 63/564,817, filed on Mar. 13, 2024, and U.S. Provisional Application No. 63/565,417, filed on Mar. 14, 2024, in the United States Patent and Trademark Office, the entire contents of which are hereby incorporated by reference.

### TECHNICAL FIELD

This disclosure relates generally to a wireless communication system, and more particularly to, for example, but not limited to, coordinated time division multiple access (TDMA) in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and procedure for transmission opportunity (TXOP) sharing which may be used to perform TDMA-based Multi-AP coordination.

An aspect of the disclosure provides a first station (STA) in a wireless network. The first STA comprises a memory and a processor coupled to the memory. The processor is configured to cause obtaining a TXOP on a wireless channel. The processor is further configured to cause transmitting, to one or more second STAs, one or more first frames, each first frame allocating a distinct portion of the TXOP for a corresponding time period, wherein each time period does not overlap with any other time period corresponding to another second STA.

In an embodiment, the first STA is an access point (AP) STA or a non-AP STA. The one or more second STAs are an AP STA or a non-AP STA.

In an embodiment, at least one first frame is a trigger frame that allocates a portion of the TXOP to a second STA to transmit a frame to the first STA.

In an embodiment, at least one first frame is a trigger frame that allocates a portion of the TXOP to a second STA to transmit a frame to other STA or the first STA.

In an embodiment, at least one first frame is a trigger frame that allocates a portion of the TXOP to a second STA, and solicits the second STA to re-allocate a portion of the allocated portion of the TXOP to another STA.

In an embodiment, the processor is further configured to cause prior to transmitting the one or more first frames, transmitting, to at least one second STA, a second frame indicating allocation of a portion of the TXOP, wherein the second frame includes an expected time duration of the allocated portion of the TXOP.

In an embodiment, the second frame is a trigger frame. The processor is further configured to cause receiving, from at least one second STA, acknowledgement frame to the second frame.

An aspect of the disclosure provides a first STA in a wireless network. The first STA comprises a memory and a processor coupled to the memory. The processor is configured to cause receiving, from a second STA, a first frame allocating a portion of the TXOP for a time period, wherein the time period does not overlap with any other time period allocated to another STA. The processor is further configured to cause performing a wireless communication during the time period in response to the first frame.

In an embodiment, the first STA is an AP STA or a non-AP STA. The second STA is an AP STA or a non-AP STA.

In an embodiment, the first frame is a trigger frame that allocates a portion of the TXOP to the first STA to transmit a frame to the second STA. The processor is further configured to cause transmitting a second frame to the first STA in response to the first frame.

In an embodiment, the first frame is a trigger frame that allocates a portion of the TXOP to the first STA to transmit a frame to another STA or the second STA.

In an embodiment, the first frame is a trigger frame that allocates a portion of the TXOP to the first STA, and solicits the first STA to re-allocate a portion of the allocated portion of the TXOP to another STA.

In an embodiment, the processor is further configured to cause prior to receiving the first frame, receiving, from the second STA, a second frame indicating allocation of the portion of the TXOP, wherein the second frame includes an expected time duration of the portion of the TXOP. The processor is further configured to cause transmitting, to the second STA, an acknowledgement frame to the second frame.

An aspect of the disclosure provides a method performed by a first STA in a wireless network. The method comprises obtaining a TXOP on a wireless channel. The method further comprises transmitting, to one or more second STAs, one or more first frames, each first frame allocating a distinct portion of the TXOP for a corresponding time period, wherein each time period does not overlap with any other time period corresponding to another second STA.

In an embodiment, the first STA is an AP STA or a non-AP STA. The one or more second STAs are an-AP STA or a non-AP STA.

In an embodiment, at least one first frame is a trigger frame that allocates a portion of the TXOP to a second STA to transmit a frame to the first STA.

In an embodiment, at least one first frame is a trigger frame that allocates a portion of the TXOP to a second STA to transmit a frame to other STA or the first STA.

In an embodiment, at least one first frame is a trigger frame that allocates a portion of the TXOP to a second STA, and solicits the second STA to re-allocate a portion of the allocated portion of the TXOP to another STA.

In an embodiment, the method further comprises, prior to transmitting the one or more first frames, transmitting, to at least one second STA, a second frame indicating allocation of a portion of the TXOP, wherein the second frame includes an expected time duration of the allocated portion of the TXOP.

In an embodiment, the second frame is a trigger frame. The method further comprises receiving, from at least one second STA, acknowledgement frame to the second frame.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example of MAP coordination in accordance with an embodiment.

FIG. 5 shows an example architecture for C-TDMA negotiation in accordance with an embodiment.

FIG. 6 shows another example architecture for C-TDMA negotiation in accordance with an embodiment.

FIG. 7 shows an example allocation of different portions of TXOP to different APs and STAs in accordance with an embodiment.

FIG. 8 shows an example allocation of TXOP to another AP using an MU-RTS Trigger frame in accordance with an embodiment.

FIG. 9 shows an example allocation of TXOP using a TXOP allocation announcement frame in accordance with an embodiment.

FIG. 10 shows an example process for MAP TXOP sharing from the sharing AP's point of view in accordance with an embodiment.

FIG. 11 shows an example process for MAP TXOP sharing from the shared AP's point of view in accordance with an embodiment.

FIG. 12 shows an example STA MLD-side EPCS enabling process for a STA MLD in accordance with an embodiment.

FIG. 13 shows an example AP MLD-side EPCS enabling process for a STA MLD in accordance with an embodiment.

FIG. 14 shows an example basic Multi-Link element format including EPCS Param Update in Unsolicited Mode Support in accordance with and embodiment.

FIG. 15 shows an example Extended MLD Capabilities And Operations subfield format including the Medium Resource Request Support subfield in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

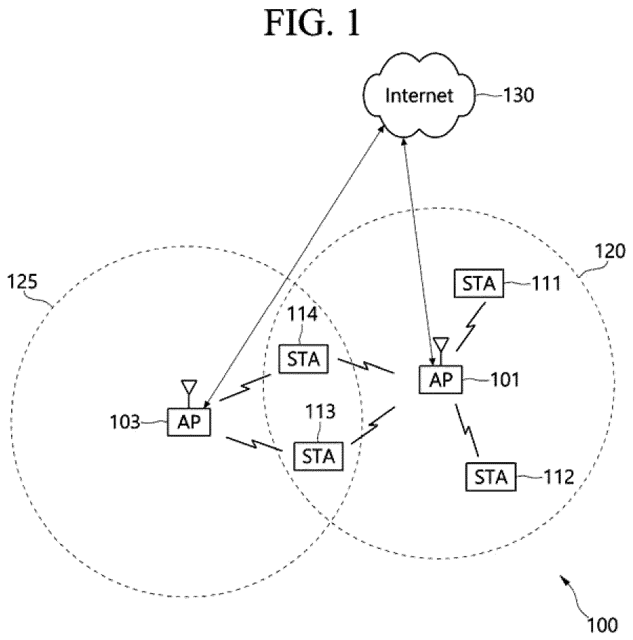

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

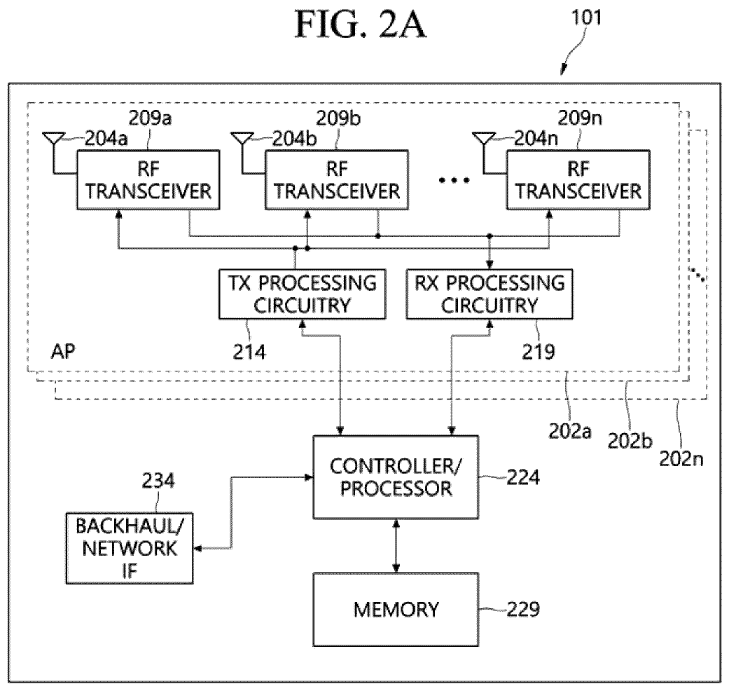

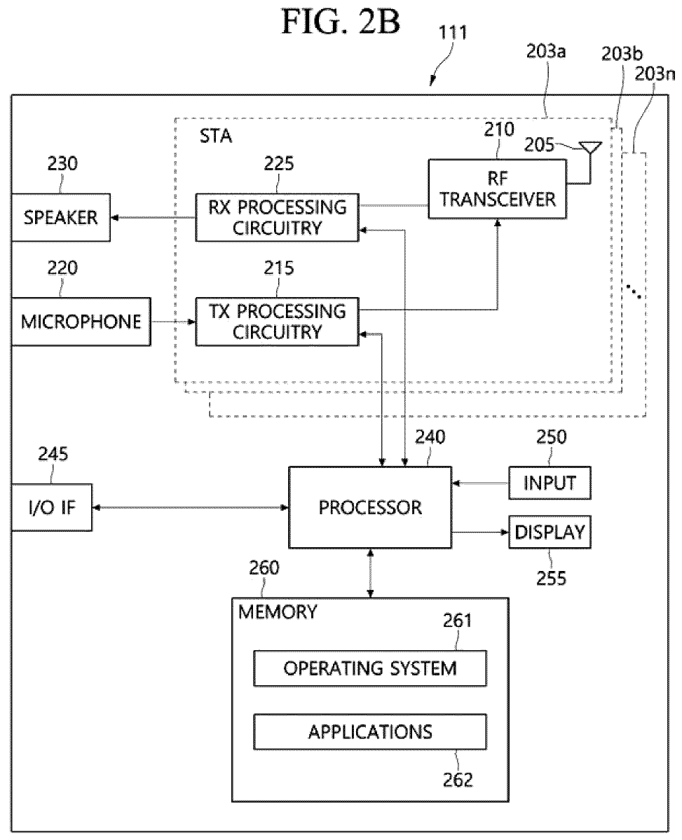

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

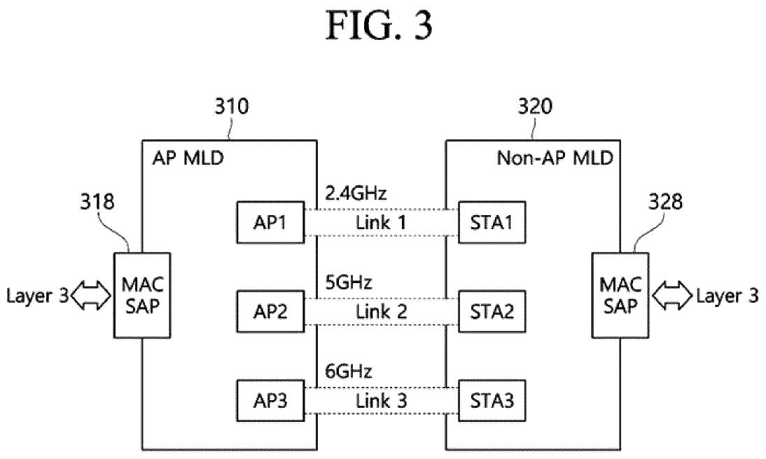

FIGS. 2 and 3 illustrate example electronic devices in accordance with an embodiment of this disclosure. In particular, FIG. 2 shows an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D4.0, “Part 11: Wireless LAN Medium Access Control (MAC) and Physical Layer (PHY) Specifications--Amendment 8: Enhancements for extremely high throughput (EHT).”

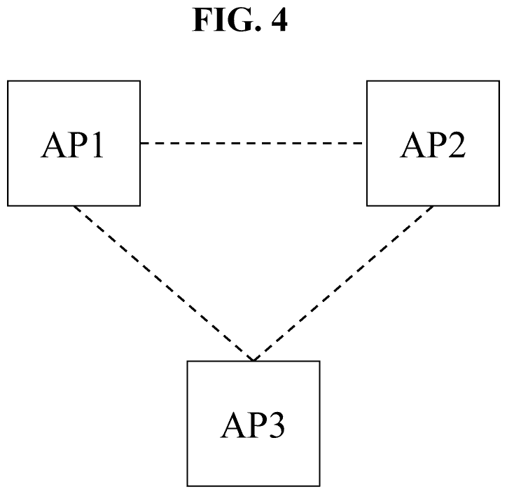

A Multi-AP (MAP) Coordination is considered as one of the key technologies for the next generation WLAN systems. In the MAP coordination, several neighboring APs coordinate with each other for improved network performance as shown in FIG. 4.

FIG. 4 shows an example of MAP coordination in accordance with an embodiment. The MAP coordination depicted in FIG. 4 is for explanatory and illustration purposes. FIG. 4 does not limit the scope of this disclosure to any particular implementation.

As shown in FIG. 4, MAP coordination may be performed in a group of APs, for example, including AP1, AP2 and AP3. AP1, AP2 and AP3 may coordinate with each other in order to reduce latency resulting from natural overall throughput degradation and/or overlapping basic service set (BSS) (OBSS) interference. As a result, AP1, AP2 and AP3 improve network performance through MAP coordination.

Interference from one BSS may cause performance issues for STAs and APs in nearby BSSs. This naturally results in overall throughput degradation in the network. The OBSS interference may increase the overall latency since it takes more time to access the channel due to the interference occupying the channel. A delay in channel access may seriously interfere an STA's latency-sensitive applications when the STA is in a BSS and has latency-sensitive traffic. Time Division Multiple Access (TDMA)-based multi-AP (MAP) coordination may be an important feature for next generation WLAN network.

In an embodiment, a first AP may coordinate with a second AP in the vicinity, such as the second AP residing in a second BSS that overlaps with a first BSS that the first AP resides in. The first AP and the second AP may coordinate on the basis of TDMA. The coordination mechanism may take different formats based on the architecture of the coordinated TDMA (C-TDMA) mechanism.

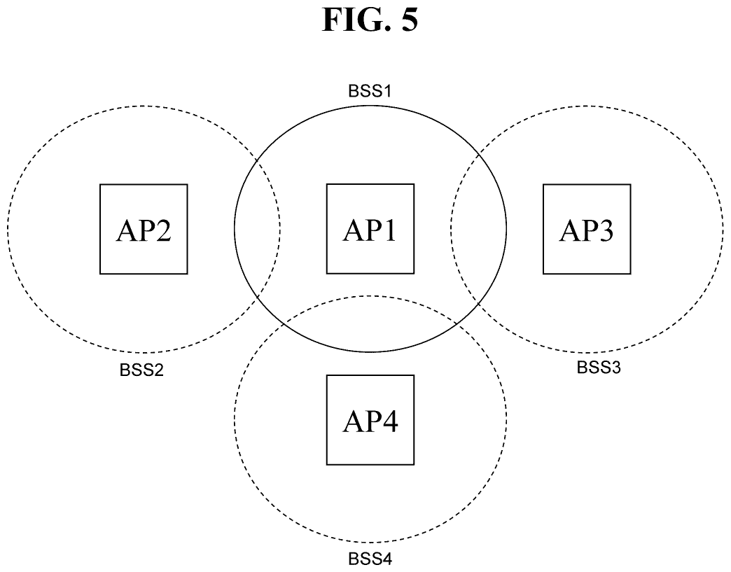

In an embodiment, an architecture, Type-I architecture, of C-TDMA negotiation, the APs participating in the TDMA-based MAP coordination may directly exchange frames within themselves to negotiate on the TDMA MAP coordination. A Type-I architecture for C-TDMA negotiation is shown in FIG. 5.

FIG. 5 shows an example architecture for C-TDMA negotiation in accordance with an embodiment. The architecture depicted in FIG. 5 is for explanatory and illustration purposes. FIG. 5 does not limit the scope of this disclosure to any particular implementation.

Referring to FIGS. 5, AP1, AP2, AP3 and AP4 form BSS1, BSS2, BSS3 and BSS4, respectively. BSS1 partially overlaps with BSS2, BSS3 and BSS4. A group of APs participating in the TDMA-based MAP coordination, including AP1, AP2, AP3 and AP4, directly exchange frames with each other to negotiate on the C-TDMA.

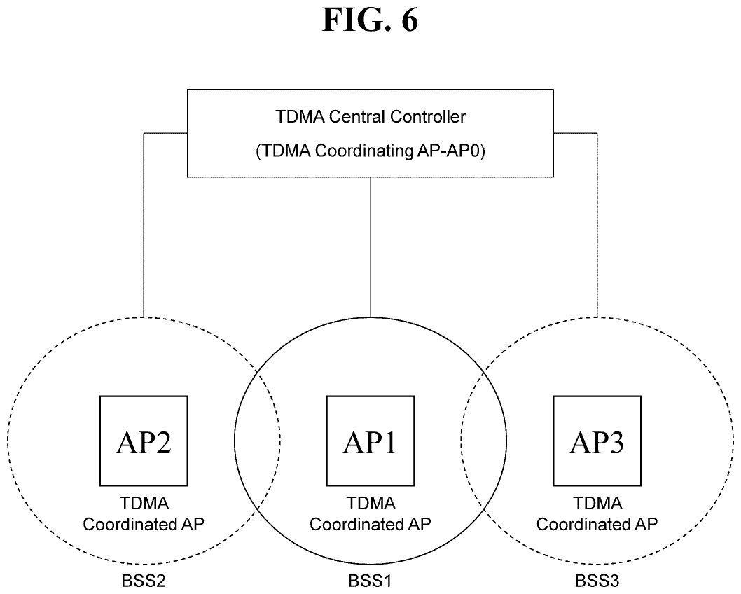

In an embodiment, in an architecture of C-TDMA negotiation (Type-II architecture), the AP's C-TDMA negotiations may be controlled by a C-TDMA central controller. The C-TDMA central controller may perform C-TDMA MAP negotiations. A Type-II architecture for C-TDMA negotiation is illustrated in FIG. 6.

FIG. 6 shows another example architecture for C-TDMA negotiation in accordance with an embodiment. The architecture depicted in FIG. 6 is for explanatory and illustration purposes. FIG. 6 does not limit the scope of this disclosure to any particular implementation.

Referring to FIGS. 6, AP1, AP2 and AP3 form BSS1, BSS2 and BSS3, respectively. BSS1 partially overlaps with BSS2 and BSS3. A group of APs participating in the TDMA-based MAP coordination, including AP1, AP2 and AP3, are coordinated by a C-TDMA Central Controller.

In an embodiment, a first STA may indicate a transmission time window for one or more STA(s). In another embodiment, the first STA and/or the second STA may be an AP STA. In another embodiment, the first STA and/or the second STA may be a non-AP STA. In another embodiment, the transmission time window may be in the form of transmission opportunity (TXOP) where the second STA is allocated TXOP for the transmission. In another embodiment, the transmission time window may indicate the time when the first STA will contend for the channel. Such transmission time windows may be inferred to be more conducive for transmission for the second STA.

In an embodiment, a first STA may share a portion of obtained TXOP with a second STA when the first STA successfully contends for the channel.

In an embodiment, a first AP may share a portion of obtained TXOP with a second AP when the first AP successfully contends for the channel.

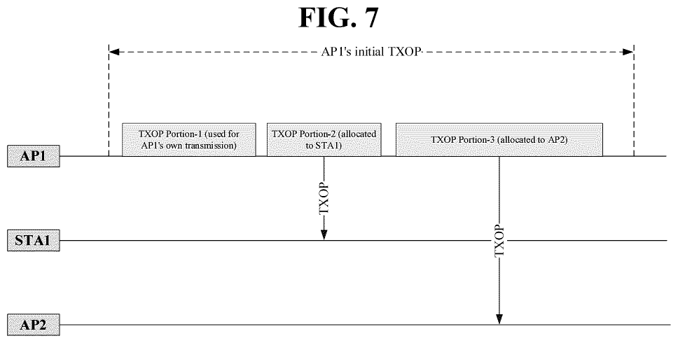

In an embodiment, a first AP may share a portion of obtained TXOP with a second AP and share another portion of obtained TXOP with one or more other STAs associated with the first AP when the first AP successfully contends for the channel as shown in FIG. 7.

FIG. 7 shows an example allocation of different portions of TXOP to different APs and STAs in accordance with an embodiment. The allocation of TXOP depicted in FIG. 7 is for explanatory and illustration purposes. FIG. 7 does not limit the scope of this disclosure to any particular implementation.

Referring to FIG. 7, AP1 initially obtains a TXOP on the wireless channel for wireless communication. AP1 uses a first portion of the obtained TXOP (“TXOP Portion-1”) for its own wireless communication. Subsequently, AP1 allocates a second portion of the obtained TXOP (“TXOP Portion-2”) to STA1 for STA1's wireless communication. Then, AP1 allocates a third portion of the obtained TXOP (“TXOP Portion-3”) to AP2 for AP2's wireless communication. As described in FIG. 7, AP1 allocates distinct portions of its obtained TXOP to other STAs (STA1 and AP2).

In an embodiment, a first AP may share multiple portions of obtained TXOP with multiple APs and/or multiple other non-AP STAs associated with the first AP when winning the contention for the channel.

In an embodiment, a first AP may transmit a multiuser request to send (MU-RTS) triggered TXOP sharing (TXS) Trigger frame to a second AP to indicate TXOP allocation from the first AP to the second AP. The MU-RTS TXS Trigger frame may indicate the duration of the TXOP.

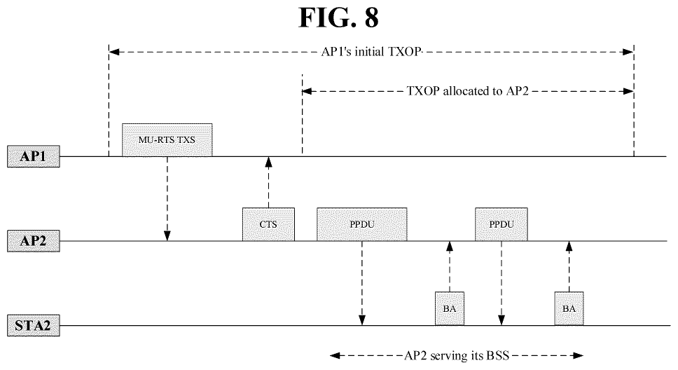

FIG. 8 shows an example allocation of TXOP to another AP using MU-RTS Trigger frame in accordance with an embodiment. The allocation depicted in FIG. 8 is for explanatory and illustration purposes. FIG. 8 does not limit the scope of this disclosure to any particular implementation.

Referring to FIG. 8, AP1 initially obtains a TXOP on a wireless channel. Then, AP1 transmits, to AP2, an MU-RTS TXS Trigger frame with its initial TXOP allocating a portion of the TXOP to AP2. In response, AP2 transmits, to AP1, a clear to send (CTS) frame. Subsequently, AP2 transmits, to STA2, a physical layer (PHY) protocol data unit (PPDU) using the allocated TXOP to serve its basic service set (BSS). In response, STA2 transmits, to AP2, a block acknowledgement (BA) frame. AP2 transmits, to STA2, another PPDU using the allocated TXOP to serve its BSS. In response, STA2 transmits, to AP2, a BA frame. As described in FIG. 8, AP1 allocates a portion of its obtained TXOP to AP2 for AP2's serving its BSS.

In an embodiment, a first AP may use different modes or versions of the MU-RTS TXS trigger frame to allocate TXOP to a second AP. A MU-RTS TXS (Mode-1) Trigger frame initiates MU-RTS TXOP sharing procedure wherein a second STA may only transmit to its associated AP. The first AP may transmit the MU-RTS TXS (Mode-1) Trigger frame when the Triggered TXOP Sharing Mode 1 Support subfield of the EHT MAC Capabilities Information field has a value of 1 indicating support for transmitting or responding to an MU-RTS TXS Trigger frame. The first AP may transmit a MU-RTS TXS (Mode-1) Trigger frame to the second AP to allocate a portion of its TXOP to the second AP. A MU-RTS TXS (Mode-2) Trigger frame initiates a MU-RTS TXOP sharing procedure wherein a second STA may transmit to its associated AP or to another STA. The first AP may transmit the MU-RTS TXS (Mode-2) Trigger frame when the Triggered TXOP Sharing Mode 2—Support subfield of the EHT MAC Capabilities Information field has a value of 1 indicating support for the transmitting or responding to an MU-RTS TXS Trigger frame. The first AP may transmit a MU-RTS TXS (Mode-2) Trigger frame to a second AP to allocate a portion of its TXOP to the second AP. The AP may use the allocated TXOP, from the MU-RTS TXS (Mode-2) Trigger frame, to transmit PPDUs to other APs or other STAs associated with the second AP. A new mode of MU-RTS TXS Trigger frame may be defined, such a mode may be referred to as Mode-3. A MU-RTS TXS (Mode-3) Trigger frame initiates a MU-RTS TXOP sharing procedure wherein a second STA may transmit as described below. A first AP may make an indication when the first AP transmits an MU-RTS TXS (Mode-3) Trigger frame to the second AP. The first AP may indicate that the second AP may use the TXOP to transmit PPDUs to the non-AP STAs associated with the second AP. The first AP may indicate that the second AP may use the TXOP to transmit PPDUs to the first AP. The first AP may indicate that the second AP may use the TXOP to transmit PPDUs to a third AP. The first AP may indicate that the second AP may further allocate different portions of the TXOP received from the first AP to one or more other non-AP STAs. The first AP may indicate that the second AP may further allocate different portions of the TXOP received from the first AP to one or more APs. The first AP may indicate a combination of any of the above-mentioned indications.

In an embodiment, a first AP, before allocating TXOP to a second AP, may transmit, to one or more APs, a message indicating that the first AP intends to allocate subsequent TXOPs to one or more APs. The message may be in the form of a TXOP allocation announcement frame.

In an embodiment, the TXOP allocation announcement frame may be a MU-RTS Trigger frame.

In an embodiment, a first AP may transmit the TXOP allocation announcement frame in a broadcast manner, such as setting the receive address (RA) to the broadcast address.

In an embodiment, a first AP may transmit the TXOP allocation announcement frame in a multi-cast manner. The frame may be destined for other APs or STAs.

In an embodiment, a second AP may transmit an acknowledgement frame to a first AP and prepare to receive subsequent TXOP from the first AP when receiving a TXOP allocation announcement frame from the first AP.

In an embodiment, a first non-AP STA associated with a first AP may transmit an acknowledgement frame to the first AP and prepare to receive subsequent TXOP from the first AP when receiving a TXOP allocation announcement frame from the first AP.

In an embodiment, a second AP or a first STA may transmit a CTS frame to the a first AP as acknowledgement to receiving a trigger frame when receiving, from the first AP, a TXOP allocation announcement frame that is transmitted in the form of a MU-RTS Trigger frame.

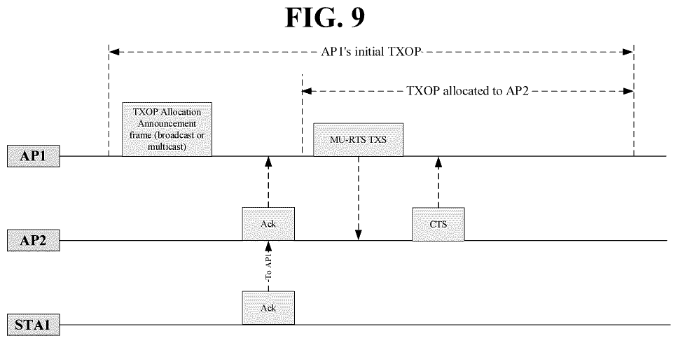

FIG. 9 shows an example allocation of TXOP using a TXOP allocation announcement frame in accordance with an embodiment. The allocation depicted in FIG. 9 is for explanatory and illustration purposes. FIG. 9 does not limit the scope of this disclosure to any particular

Referring to FIG. 9, AP1 initially obtains a TXOP on a wireless channel. Then, AP1 transmits, to AP2 and STA1, a TXOP allocation announcement frame via either broadcast or multicast using a portion of AP1's initial TXOP. In response AP2 transmits, to AP1, an acknowledgement (ACK) frame and STA1 transmits, to AP1, an ACK frame. In response, AP1 transmits, to AP2, a MU-RTS TXS Trigger frame allocating a portion of AP1's initial TXOP to AP2. In response, AP2 transmits, to AP1, a CTS frame. Subsequently, AP2 may use the portion of TXOP for its communications. As described in FIG. 9, AP1 allocates TXOP to AP2 using a TXOP Allocation Announcement frame to indicate to AP2 and STA1 that AP1 intends to allocate TXOP to AP2.

In an embodiment, the TXOP allocation announcement frame may include some time schedule to indicate when the recipient of the frame can expect to receive a subsequent TXOP. The TXOP allocation announcement frame may include the duration of the expected TXOP. The TXOP allocation announcement frame may include the user information for which the TXOP is intended. The TXOP allocation announcement frame may include expected time of arrival of the subsequent TXOP. The TXOP allocation announcement frame may include the modes of TXOP to arrive subsequently. The TXOP allocation announcement frame may include the traffic identifier (TID) or priority of the traffic that is permitted to be transmitted during the allocated TXOP. The TXOP allocation announcement frame may include any restriction placed on the TXOP usage.

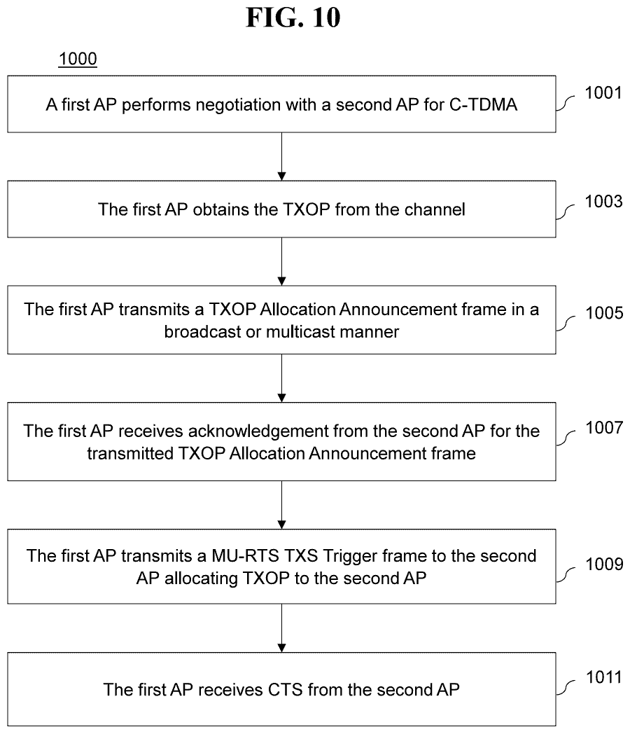

FIG. 10 shows an example process for MAP TXOP sharing from the sharing AP's point of view in accordance with an embodiment. The process depicted in FIG. 10 is for explanatory and illustration purposes. FIG. 10 does not limit the scope of this disclosure to any particular implementation.

Referring to FIG. 10, the process 1000 begins at operation 1001. In operation 1001, a first AP performs negotiation with a second AP for C-TDMA.

In operation 1003, the first AP obtains the initial TXOP by successfully contending for the channel.

In operation 1005, the first AP transmits, to the second AP, a TXOP allocation announcement frame in a broadcast or multicast manner.

In operation 1007, the first AP receives, from the second AP, acknowledgement frame acknowledging receipt of the transmitted TXOP allocation announcement frame.

In operation 1009, the first AP transmits a MU-RTS TXS Trigger frame to the second AP allocating a portion of the obtained TXOP to the second AP. The first AP may also indicate the mode and duration of the TXOP. For example and without limitation, the trigger frame may be a MU-RTS TXS (Mode-1) Trigger frame, a MU-RTS TXS (Mode-2) Trigger frame, or a MU-RTS TXS (Mode-3) Trigger frame.

In operation 1011, the first AP receives, from the second AP, a CTS frame. Subsequently, the second AP may perform transmissions using the portion of TXOP

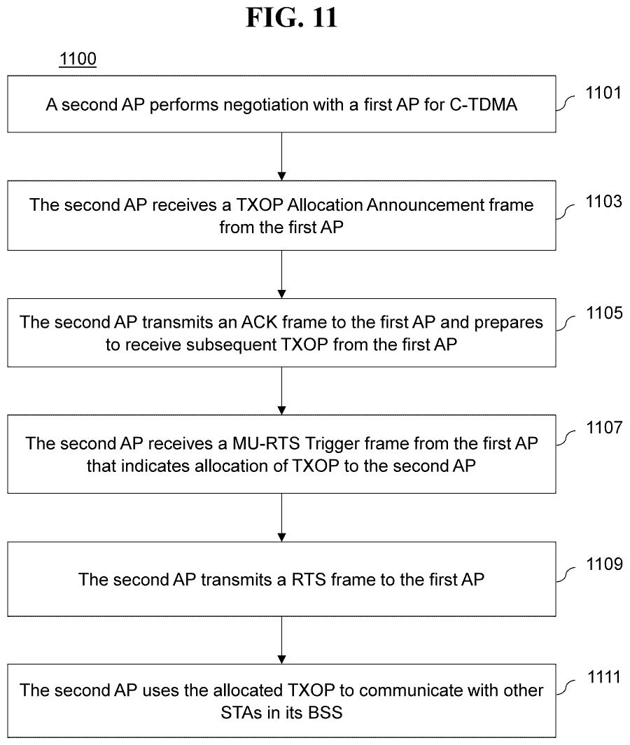

FIG. 11 shows an example process for MAP TXOP sharing from the shared AP's point of view in accordance with an embodiment. The process depicted in FIG. 11 is for explanatory and illustration purposes. FIG. 11 does not limit the scope of this disclosure to any particular implementation.

Referring to FIG. 11, the process 1100 begins at operation 1101. In operation 1101, a second AP performs negotiation with a first AP for C-TDMA.

In operation 1103, the second AP receives, from the first AP, a TXOP allocation announcement frame indicating that the first AP intends to allocate a portion of the obtained TXOP.

In operation 1105, the second AP transmits, to the first AP, an ACK frame and prepares to receive, from the first AP, the indicated portion of the obtained TXOP.

In operation 1107, the second AP receives, from the first AP, a MU-RTS Trigger frame allocating a portion of the obtained TXOP to the second AP. The first AP may also indicate the mode and duration of the TXOP. For example and without limitation, the trigger frame may be a MU-RTS TXS (Mode-1) Trigger frame, a MU-RTS TXS (Mode-2) Trigger frame, or a MU-RTS TXS (Mode-3) Trigger frame.

In operation 1109, the second AP transmits, to the first AP, a RTS frame to the first AP.

In operation 1111, the second AP uses portion of the allocated TXOP to communicate with other STAs in its BSS. Subsequently, the second AP may perform transmissions using the portion of TXOP

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP (STA) MLD to discover, authenticate, associate, and set up multiple links with an AP MLD. Channel access and frame exchange is possible on each link between the AP MLD and STA MLD.

Emergency Preparedness Communication Services (EPCS) priority access features are currently being developed for IEEE 802.11be specifications. With EPCS capability enabled, a device is capable of obtaining higher priority in channel access over non-EPCS devices. For EPCS, the AP MLD assigns higher priority enhanced distributed channel access (EDCA) parameters to the devices with EPCS features enabled.

A STA MLD enables the EPCS feature through negotiation with the AP MLD. The EPCS access is granted on an individual basis. The STA MLD may use higher priority EDCA parameters after receiving approval from the AP MLD.

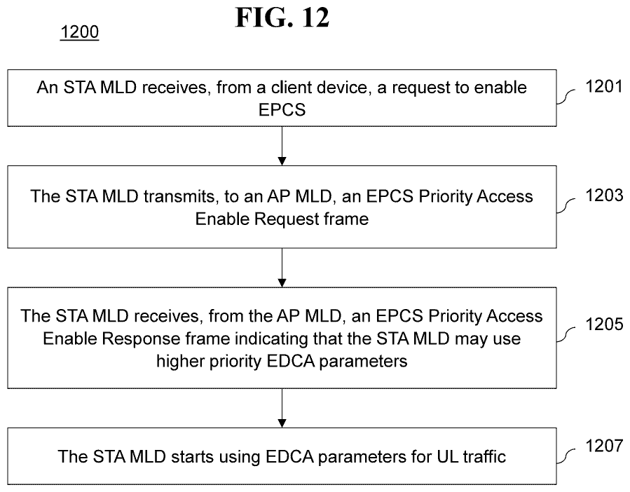

FIG. 12 shows an example STA MLD-side EPCS enabling process for a STA MLD in accordance with an embodiment. The process depicted in FIG. 12 is for explanatory and illustration purposes. FIG. 12 does not limit the scope of this disclosure to any particular implementation.

Referring to FIG. 12, the process 1200 begins at operation 1201. In operation 1201, a STA MLD receives, from a client device, a request to enable EPCS. The STA MLD may have EPCS capability enabled. The client device may have EPCS capability enabled.

In operation 1203, the STA MLD transmits, to an AP MLD, an EPCS Priority Access Enable Request frame requesting higher priority EDCA parameters on behalf of the client device. The STA MLD may enable the EPCS feature through the AP MLD in this way.

In operation 1205, the STA MLD receives, from the AP MLD, an EPCS Priority Access Enable Response frame indicating that the STA MLD may use higher priority EDCA parameters.

In operation 1207, the STA MLD starts using higher priority EDCA parameters for uplink (UL) traffic. The client device and the STA MLD may use the higher priority EDCA parameters in their communications between them.

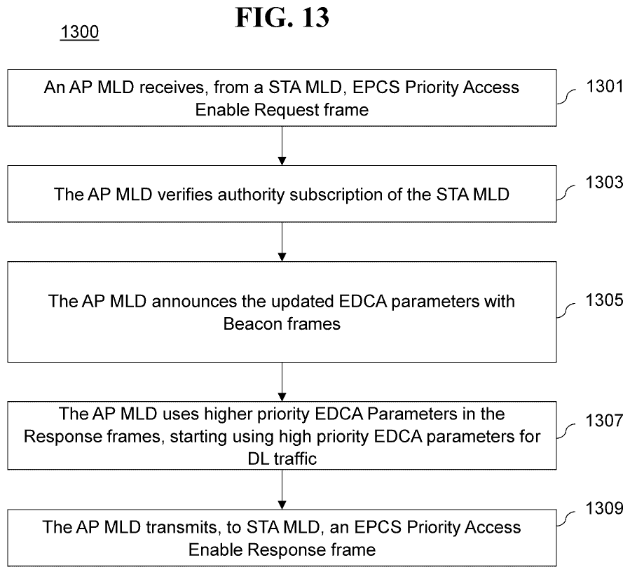

FIG. 13 shows an example AP MLD-side EPCS enabling process for a STA MLD in accordance with an embodiment. The process depicted in FIG. 13 is for explanatory and illustration purposes. FIG. 13 does not limit the scope of this disclosure to any particular

Referring to FIG. 13, the process 1300 begins at operation 1301. In operation 1301, an AP MLD receives, from a STA MLD, EPCS Priority Access Enable Request frame. The STA MLD may have EPCS capability enabled.

In operation 1303, the AP MLD verifies authority subscription of the STA MLD. The AP MLD may determine if the STA MLD has EPCS capability enabled and may determine to assign higher priority EPCS parameters to the STA MLD.

In operation 1305, the AP MLD announces the updated EDCA parameters with Beacon frames.

In operation 1307, the AP MLD uses higher priority EDCA Parameters in the Response frames. The AP MLD may start using higher priority EDCA parameters for downlink (DL) traffic.

In operation 1309, the AP MLD transmits, to STA MLD, an EPCS Priority Access Enable Response frame. The AP MLD may transmit EPCS Priority Access Enable Response frame using the higher priority EDCA Parameters.

In an embodiment, an AP MLD may indicate its support for the EPCS priority access parameter update procedure in unsolicited mode by appropriately setting the EPCS Priority Access in Unsolicited Mode Support subfield in the Extended Capabilities field in the Extended Capabilities field in the Extended Capabilities element that the AP MLD transmits. The Priority Access in Unsolicited Mode Support subfield may indicate that the AP MLD supports the EPCS parameter update procedure in unsolicited mode when set to a value of 1. The AP MLD may not support the EPCS parameter update in unsolicited mode when the Priority Access in Unsolicited Mode Support subfield is not set to a value of 1. The corresponding subfield on the Extended Capabilities field is shown in Table 1.

TABLE 1

| Bit | Information | Notes |
|---|---|---|
| . . . | | |
| <ANA> | EPCS Priority | The AP MLD sets the EPCS Priority Access in Unsolicited Mode |
| | Access in | Support subfield to 1 if the AP MLD supports the EPCS priority |
| | Unsolicited | access parameter update procedure in unsolicited mode. |
| | Mode Support | Otherwise, the AP MLD sets the EPCS Priority Access in |
| | | Unsolicited Mode Support subfield to 0. |

In an embodiment, a STA MLD may indicate that the STA MLD supports the EPCS priority access parameter update procedure in unsolicited mode by appropriately setting the EPCS Priority Access in Unsolicited Mode Support subfield in the Extended Capabilities field in the Extended Capabilities element that the STA MLD transmits. The Priority Access in Unsolicited Mode Support subfield may indicate that the STA MLD supports the EPCS parameter update procedure in unsolicited mode when set to a value of 1. The STA MLD may not support the EPCS parameter update in unsolicited mode when the Priority Access in Unsolicited Mode Support subfield is not set to a value of 1. The corresponding subfield on the Extended Capabilities field is shown in Table 2.

TABLE 2

| Bit | Information | Notes |
|---|---|---|
| . . . | | |
| <ANA> | EPCS Priority | The STA MLD sets the EPCS Priority Access in Unsolicited |
| | Access in | Mode Support subfield to 1 if the STA MLD supports the EPCS |
| | Unsolicited | priority access parameter update procedure in unsolicited mode. |
| | Mode Support | Otherwise, the STA MLD sets the EPCS Priority Access in |
| | | Unsolicited Mode Support subfield to 0. |

In an embodiment, an STA MLD may indicate its support for the EPCS priority access parameter update procedure in unsolicited mode by appropriately setting the EPCS Param Update in Unsolicited Mode Support subfield in MLD Capabilities and Operations subfield in the Common Info field of the Basic Multi-Link element. The EPCS Param Update in Unsolicited Mode Support subfield may indicate that the STA MLD supports the EPCS parameter update procedure in unsolicited mode when set to 1. The STA MLD may not support the EPCS parameter update procedure in unsolicited mode when the EPCS Param Update in Unsolicited Mode Support subfield is not set to 1.

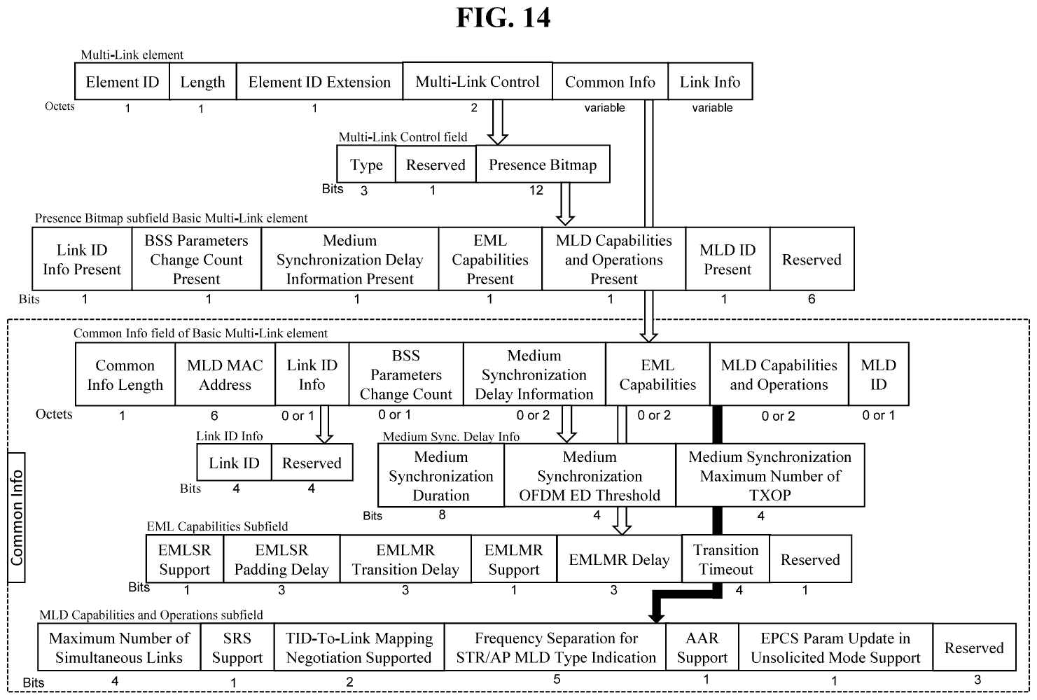

In an embodiment, an AP MLD may indicate its support for the EPCS priority access parameter update procedure in unsolicited mode by appropriately setting the EPCS Param Update in Unsolicited Mode Support subfield in MLD Capabilities and Operations subfield in the Common Info field of the Basic Multi-Link element. The EPCS Param Update in Unsolicited Mode Support subfield may indicate that the AP MLD supports the EPCS parameter update procedure in unsolicited mode when set to 1. The AP MLD may not support the EPCS parameter update procedure in unsolicited mode when the EPCS Param Update in Unsolicited Mode Support subfield is not set to 1. The corresponding subfield in the Basic Multi-Link element is shown in FIG. 14.

FIG. 14 shows an example basic Multi-Link element format including EPCS Param Update in Unsolicited Mode Support in accordance with and embodiment. The format depicted in FIG. 14 is for explanatory and illustration purposes. FIG. 14 does not limit the scope of this disclosure to any particular implementation.

Referring to FIG. 14, the basic Multi-Link element comprises an Element ID field, a Length field, an Element ID Extension field, a Multi-Link Control field, a Common Info field and a Link Info field. The Element ID field includes an identifier of the element. The Length field includes an indication of the number of octets in the element excluding the Element ID field and the Length field. The Element ID Extension field includes a part of the identifier of the element. The Multi-Link Control field includes an indication of the type of variant of the Multi-Link element. The Common Info field includes information that is common to all links. The Link Info field includes information specific to one or more links.

The Common Info field comprises a Common Info Length subfield, a MLD MAC Address subfield, a LinkID Info subfield, a BSS Parameters Change Count subfield, a Medium Synchronization Delay Information subfield, an EML Capabilities subfield, a MLD Capabilities and Operations subfield and a MLD ID subfield. The Common Info Length subfield includes an indication of the number of octets in the Common Info field, including one octet for the Common Info Length subfield. The MLD MAC Address subfield includes the MAC Address of the MLD described by the Basic Multi-Link element. The LinkID Info subfield includes an indication of the link identifier of the AP that is affiliated with the AP MLD which is described in the Basic Multi-Link element and satisfies either that the AP transmitted the Basic Multi-Link element or the AP corresponds to a non-transmitted BSSID that is a member of the same multiple BSSID set as the AP that transmitted the Multiple BSSID element containing the profile for the non-transmitted BSSID which includes the Basic Multi-Link element (affiliate AP MLD). The BSS Parameters Change Count subfield includes a value that indicates the number of critical updates that have occurred to the BSS parameters of the AP that is affiliated with the affiliate AP MLD. The Medium Synchronization Delay Information subfield includes the duration value of the medium synchronization timer in units of 32 us. The EML Capabilities subfield includes indications of the capabilities for EMLSR operation and EMLMR operation. The MLD Capabilities and Operations subfield includes subfields for MLD capabilities and operations defined below. The MLD ID subfield includes an identifier of the MLD whose MLD information is carried in the Basic Multi-Link element.

The MLD Capabilities and Operations subfield comprises a Maximum Number of Simultaneous Links subfield, a SRS Support subfield, a TID-To-Link Mapping Negotiation Supported subfield, a Frequency Separation for STR/AP MLD Type Indication subfield, an AAR Support subfield, an EPCS Param Update in Unsolicited Mode Support subfield and a reserved subfield. The Maximum Number of Simultaneous Link subfield indicates the maximum number of STAs affiliated with the MLD that support simultaneous transmission or reception of frames on the respective link. The SRS Support subfield indicates support for the reception of a frame that carries an SRS Control subfield. The TID-To-Link Mapping Negotiation Support subfield indicates support for TTLM negotiation. The Frequency Separation For STR/AP MLD Type Indication subfield indicates the minimum frequency gap between any two links that is recommended by the non-AP MLD for STR operation, where the frequency gap is specified as the difference between the nearest frequency edges of the two links, or indicates the type of an AP MLD. The AAR Support subfield indicates support for receiving a frame with an AAR Control subfield. The EPCS Param Update in Unsolicited Mode Support subfield indicates support for the EPCS priority access parameter update procedure in unsolicited mode to the AP MLD.

In an embodiment, an AP MLD may not transmit a message to a STA MLD in EPCS mode to update the EPCS priority access parameters for the STA MLD in an unsolicited mode when the STA MLD has not indicated its support for the EPCS priority access parameter update procedure in unsolicited mode to the AP MLD. In another embodiment, the STA MLD may not indicate its support to the associated AP MLD for EPCS priority access parameter update procedure in unsolicited mode if the AP MLD has not also indicated its support for the feature.

In an embodiment, a first STA may transmit, to an associated AP, a request for medium resources, such as a TXOP, for transmission to a second STA that is a peer STA of the first STA. In another embodiment, a STA may support receiving a Medium Resource Request (MRR) Control subfield that solicited medium time based on the value set in the Medium Resource Request Support subfield in the Extended MLD Capabilities And Operations subfield of a Basic Multi-Link element.

In an embodiment, an AP may set the Medium Resource Request Support subfield in the Extended MLD Capabilities And Operations subfield of the Basic Multi-Link element that the AP transmits to 1 when the AP supports receiving a request from a STA for medium resources. The AP may, for example and without limitation, support receiving a MRR Control subfield in an A-Control field. The AP may support receiving the medium resource request from a STA when the Medium Resource Request Support subfield is set to 1. The AP may not support receiving the medium resources if the Medium Resource Request Support subfield is not set to 1.

In an embodiment, a STA may set the Medium Resource Request Support subfield in the Extended MLD Capabilities And Operations subfield of the Basic Multi-Link element that an AP transmits to 1 when the STA supports transmitting a request to the AP for medium resources. The STA may, for example and without limitation, support transmitting a request to an AP for medium resources when the STA supports transmitting an MRR Control subfield in an A-Control field. The STA may support transmitting the medium resource request to the AP when the Medium Resource Request Support subfield is set to 1. The STA may not support transmitting the medium resource request to the AP when the Medium Resource Request Support subfield is not set to 1.

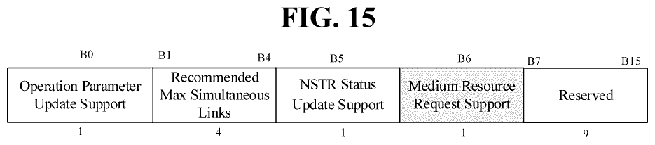

FIG. 15 shows an example Extended MLD Capabilities And Operations subfield format including the Medium Resource Request Support subfield in accordance with an embodiment. The format depicted in FIG. 15 is for explanatory and illustration purposes. FIG. 15 does not limit the scope of this disclosure to any particular implementation.

Referring to FIG. 15, the Extended MLD Capabilities And Operations subfield comprises an Operation Parameter Update Support subfield, a Recommended Max Simultaneous Links subfield, a NSTR Status Update Support subfield, a Medium Resource Request Support subfield and a reserved subfield. The Operation Parameter Update Support subfield indicates support of operation parameters update negotiation. The Recommended Max Simultaneous Links subfield indicates the maximum number of enabled links that a non-AP MLD may operate on for simultaneous frame exchanges. The NSTR Status Update Support subfield indicates support of NSTR status update procedure. The Medium Resource Request Support subfield indicates support for receiving or transmitting frames with an MRR Control subfield.

Subfields of the Extended MLD Capabilities And Operations subfield are shown in Table 5.

TABLE 5

| Subfield | Definition | Encoding |
|---|---|---|
| . . . | . . . | . . . |
| NSTR Status Update | Indicates support of | Set to 1 if |
| Report | NSTR status update | dot11NSTRStatusUpdateImplemented |
| | procedure | is true. |
| | | Set to 0 otherwise; |
| Medium Resource | For an AP, indicates | Set to 1 if |
| Request Support | support of receiving | dot11MediumResourceRequestImplemented |
| | frames with an MRR | is true. |
| | Control subfield. | Set to 0 otherwise. |
| | For a STA, indicates | |
| | support of transmitting | |
| | frames with an MRR | |
| | Control subfield. | |

In an embodiment, a STA or a STA MLD may not transmit a Medium resource request or an MRR Control subfield in A-Control field to an AP or AP MLD when the AP or the AP MLD has not indicated its support for receiving the Medium resource request or an MRR Control subfield in A-Control field by setting the Medium Resource Request Support in the Basic Multi-Link element to 1.

In an embodiment, the management information base (MIB) detail for Medium Resource Request Support is shown in Table 6.

TABLE 6
C.3 MIB Detail
Dot11EHTSTAConfigEntry ::=
SEQUENCE {

| | |
|---|---|
| dot11EHTPPEThresholdsRequired | TruthValue, |
| dot11TIDtoLinkMappingActivated | TruthValue, |
| dot11EHTEPCSPriorityAccessActivated | TruthValue, |
| dot11MSDTimerDuration | Unsigned32, |
| dot11MSDTXPMax | Unsigned32, |
| dot11MultiLinkActivated | TruthValue, |
| dot11MLDAssociationSAQueryMaximumTimeout | Unsigned32, |
| dot11EHTMCSFeedbackOptionImplemented | INTEGER, |
| dot11EHTEMLSROptionImplemented | TruthValue, |
| dot11EHTEMLSROptionActivated | TruthValue, |
| dot11EHTEMLMROptionImplemented | TruthValue, |
| dot11EHTEMLMROptionActivated | TruthValue, |
| dot11OperationParameterUpdateImplemented | TruthValue, |
| dot11EHTLinkReconfigurationOperationActivated | TruthValue, |
| dot11MultiLinkTrafficIndicationActivated | TruthValue, |
| dot11NSTRStatusUpdateImplemented | TruthValue, |
| dot11MediumResourceRequestImplemented | TruthValue |

```
}
dot11MediumResourceRequestImplemented OBECT-TYPE
  SYNTAX Truth
  MAX-ACCESS read only
  STATUS current
  DESCRIPTION
  “This is a capability variable.
  Its value is determined by device capabilities. This attribute, when true, indicates that the STA
  implementation is capable of supporting medium resource request.”
  DEVFAL { false }
  ::= { dot11EHTStationConfigEntry17 }
```

Referring to Table 6, the Dot11EHTSTAConfigEntry comprises a SEQUENCE and a dot11MediumResourceRequest Implemented OBJECT-TYPE. The SEQUENCE includes information associated with supporting medium resource requests for a STA implementation. The do11MediumResourceRequestImplemented OBJECT-TYPE includes information indicating if the STA implementation is capable of supporting medium resource requests.

The disclosure provides mechanisms and procedures for TDMA-based MAP coordination, such as TXOP sharing being used to perform TDMA-based MAP coordination improving overall network performance.

According to various embodiments, a first STA requests, from an AP, a resource on behalf of a second STA so that AP will be able to efficiently allocate time (or TXOP) of the pending traffic from the first STA to the second or from the second STA to the first STA in their P2P communication, so that latency sensitive traffic may be delivered in a timely manner.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, comprising:
a memory; and
a processor coupled to the memory, the processor configured to cause:
obtaining a transmission opportunity (TXOP) on a wireless channel; and
transmitting, to one or more second STAs, one or more first frames, each first frame allocating a distinct portion of the TXOP for a corresponding time period, wherein each time period does not overlap with any other time period corresponding to another second STA.

2. The first STA of claim 1, wherein:
the first STA is an access point (AP) STA or a non-AP STA; and
the one or more second STAs are an AP STA or a non-AP STA.

3. The first STA of claim 1, wherein at least one first frame is a trigger frame that allocates a portion of the TXOP to a second STA to transmit a frame to the first STA.

4. The first STA of claim 1, wherein at least one first frame is a trigger frame that allocates a portion of the TXOP to a second STA to transmit a frame to other STA or the first STA.

5. The first STA of claim 1, wherein at least one first frame is a trigger frame that allocates a portion of the TXOP to a second STA, and solicits the second STA to re-allocate a portion of the allocated portion of the TXOP to another STA.

6. The first STA of claim 1, wherein the processor is further configured to cause:
prior to transmitting the one or more first frames, transmitting, to at least one second STA, a second frame indicating allocation of a portion of the TXOP, wherein the second frame includes an expected time duration of the allocated portion of the TXOP.

7. The first STA of claim 6, wherein the second frame is a trigger frame; and
the processor is further configured to cause:
receiving, from at least one second STA, acknowledgement frame to the second frame.

8. A first station (STA) in a wireless network, comprising:
a memory; and
a processor coupled to the memory, the processor configured to cause:
receiving, from a second STA, a first frame allocating a portion of the transmission opportunity (TXOP) for a time period, wherein the time period does not overlap with any other time period allocated to another STA;
performing a wireless communication during the time period in response to the first frame.

9. The first STA of claim 8, wherein:
the first STA is an access point (AP) STA or a non-AP STA; and
the second STA is an AP STA or a non-AP STA.

10. The first STA of claim 8, wherein:
the first frame is a trigger frame that allocates a portion of the TXOP to the first STA to transmit a frame to the second STA; and
the processor is further configured to cause transmitting a second frame to the first STA in response to the first frame.

11. The first STA of claim 8, wherein:
the first frame is a trigger frame that allocates a portion of the TXOP to the first STA to transmit a frame to another STA or the second STA.

12. The first STA of claim 8, wherein the first frame is a trigger frame that allocates a portion of the TXOP to the first STA, and solicits the first STA to re-allocate a portion of the allocated portion of the TXOP to another STA.

13. The first STA of claim 8 wherein the processor is further configured to cause:
prior to receiving the first frame, receiving, from the second STA, a second frame indicating allocation of the portion of the TXOP, wherein the second frame includes an expected time duration of the portion of the TXOP; and
transmitting, to the second STA, an acknowledgement frame to the second frame.

14. A method performed by a first station (STA) in a wireless network, the method comprising:
obtaining a transmission opportunity (TXOP) on a wireless channel; and
transmitting, to one or more second STAs, one or more first frames, each first frame allocating a distinct portion of the TXOP for a corresponding time period, wherein each time period does not overlap with any other time period corresponding to another second STA.

15. The method of claim 14, wherein:
the first STA is an access point (AP) STA or a non-AP STA; and
the one or more second STAs are an-AP STA or a non-AP STA.

16. The method of claim 14, wherein at least one first frame is a trigger frame that allocates a portion of the TXOP to a second STA to transmit a frame to the first STA.

17. The method of claim 14, wherein at least one first frame is a trigger frame that allocates a portion of the TXOP to a second STA to transmit a frame to other STA or the first STA.

18. The method of claim 14, wherein at least one first frame is a trigger frame that allocates a portion of the TXOP to a second STA, and solicits the second STA to re-allocate a portion of the allocated portion of the TXOP to another STA.

19. The method of claim 14, wherein the method further comprises:
prior to transmitting the one or more first frames, transmitting, to at least one second STA, a second frame indicating allocation of a portion of the TXOP, wherein the second frame includes an expected time duration of the allocated portion of the TXOP.

20. The method of claim 19, wherein:
the second frame is a trigger frame; and
the method further comprises receiving, from at least one second STA, acknowledgement frame to the second frame.
